(19) United States
(12) Patent Application Publication
(10) Pub. No.: US 2024/0168166 A1
(43) Pub. Date: May 23, 2024

(54) Processing LiDAR Data

(71) Applicant: ROCK Robotic Inc., Denver, CO (US)

(72) Inventors: Alexander R Knoll, Denver, CO (US); Harrison L Knoll, Menlo Park, CA (US); Christopher Lee, Albuquerque, NM (US); Timothy Whitney, Englewood, CO (US); Leo N Stanislas, Rueil-Malmaison (FR)

(21) Appl. No.: 18/512,881

(22) Filed: Nov. 17, 2023

Related U.S. Application Data
(60) Provisional application No. 63/384,164, filed on Nov. 17, 2022.

(51) Int. Cl. G01S 17/89; G06T 9/00; G06T 9/40

(52) U.S. Cl. CPC G01S 17/89; G06T 9/001; G06T 9/40

(57) ABSTRACT

Systems and methods for surveying ground environments and processing LiDAR data are disclosed. In an aspect, LiDAR data in the form of point clouds are adjusted or manipulated by a processor in order to improve the accuracy of the LiDAR data and make the data more useful for surveyors, builders, and the like. Systems and methods described herein may improve LiDAR point cloud data by aligning one or more LiDAR point clouds with LiDAR point clouds of the same environment of known high accuracy. Systems and methods described herein are further directed to techniques for reprojecting LiDAR datasets from a first coordinate system to a second coordinate system with better efficiency and processing speed than existing techniques.

### CROSS-REFERENCE TO RELATED APPLICATION(S)

This application claims the priority benefit, under 35 U.S.C. 119(e), of U.S. Application No. 63/384, 164, filed Nov. 17, 2022, which is incorporated herein by reference in its entirety for all purposes.

### BACKGROUND

Land surveying is the process of determining a shape or topology of the ground and features on the ground using various metrology techniques. Recent developments in sensor and drone technology have enabled the development of aerial surveying systems, which have the advantageous capability of surveying large areas in shorter amounts of time than ground-based techniques. However, these systems may generate large amounts of data and existing techniques for processing and integrating the data with existing survey datasets often fail to meet state-of-the-art requirements for processing speed and ease of use.

### SUMMARY

The performance of a light detection and ranging (LiDAR) sensor can be monitored using the LiDAR itself. More specifically, the LiDAR sensor can acquire a first dataset representing a first scene, e.g., by flying over the first scene on or suspended from a drone. After measuring the first dataset, the LiDAR sensor acquires a second dataset representing a second scene, which can be the same as or different than the first scene. A processor performs a statistical analysis of points in the first dataset representing a flat area in the first scene and a statistical analysis of points in the second dataset representing a flat area in the second scene. The processor performs a comparison of these statistical analyses and can determine, based on the comparison, if the LiDAR sensor is out of calibration.

In some aspects, performing the statistical analysis of points in the first dataset representing the flat area in the first scene can include calculating an average thickness of the points for a distance between the LiDAR sensor and the first scene and a standard deviation of altitudes among the points. If the LiDAR sensor acquires the first dataset by making multiple passes over the flat area in the first scene, performing the statistical analysis of points in the first dataset representing the flat area in the first scene can include calculating an average deviation of the points.

In some aspects, the techniques described herein relate to a method for point cloud reprojection, the method including compressing, by a processor, a LiDAR point cloud associated with a first coordinate system into a canonical dataset arranged in a tree structure having a plurality of nodes, each node including coordinates, and each node being associated with one or more children; creating, by the processor, a parallel copy of the LiDAR point cloud, the parallel copy arranged in the tree structure and having a plurality of parallel nodes corresponding to the plurality of nodes of the canonical dataset; for each node of at least a spatial subset of the plurality of parallel nodes, loading, by the processor, that node and the corresponding node of the canonical dataset; reprojecting, by the processor, the coordinates of that node into a second coordinate system; and replacing, by the processor, the coordinates of the corresponding node of the canonical dataset with the reprojected coordinates.

In some aspects, the tree structure is an octree structure.

In some aspects, the canonical dataset is segmented into a plurality of variable-length chunks.

In some aspects, the coordinates include Cartesian coordinates, polar coordinates, or spherical coordinates.

In some aspects, reprojecting the coordinates of that node includes applying an affine matrix transformation to each of the coordinates in that node.

In some aspects, the compressing includes a lossless compression.

In some aspects, at least a spatial subset of nodes of the canonical dataset includes all of the nodes of the canonical dataset.

In some aspects, the techniques described herein relate to a method for automatically updating a topographic map, the method including classifying, by a processor, light detection and ranging (LiDAR) data points representing the ground and an object, the object having a substantially level base, and each of the LiDAR data points including a surface elevation value; joining, by the processor, the LiDAR data points representing the ground in a contiguous mesh; representing, by the processor, the object as a polygon including at least three LiDAR data points, the at least three LiDAR data points including elevation values equal to a lowest surface elevation value for the object; defining, by the processor, the polygon as a breakline for the object; routing, by the processor, at least one contour line through the contiguous mesh and around the breakline; and updating, by the processor, the topographic map using the routed at least one contour line and the breakline.

In some aspects, the contiguous mesh includes a triangulated irregular network, a quadrilateral structured grid, a hexahedral structured grid, or a hybrid grid.

In some aspects, the object includes a building, a road, or another human-made structure.

In some aspects, the polygon is a triangle, a quadrilateral, a regular polygon, or an irregular polygon.

In some aspects, the techniques described herein further include displaying, to a user, the topographic map.

In some aspects, the techniques described herein further include determining a flight path for an unmanned aerial vehicle (UAV) or drone based on the updated topographic map and operating the UAV using the flight path.

In some aspects, the techniques described herein further include operating a UAV to follow a flight path based on the object.

In some aspects, the techniques described herein relate to a method for point cloud alignment, the method including representing, by at least one processor, at least a first portion of a first point cloud using a tree structure, the first point cloud including terrestrially acquired data; representing, by the at least one processor, at least a second portion of a second point cloud using the tree structure, the second point cloud including aerially acquired data; calculating, by the at least one processor, a transformational matrix for aligning a first set of control points in the at least a first portion with a second set of control points in the at least a second portion; and matching, by the at least one processor, the at least a first portion with the at least a second portion.

In some aspects, the matching includes applying an affine transformation of the at least a first portion or the at least a second portion using the transformational matrix.

In some aspects, the affine transformation includes a rotation or a translation.

In some aspects, the tree structure is an octree structure.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1A illustrates a system for collecting and processing LiDAR data of an environment in accordance with the present technology.

FIG. 1B illustrates a simultaneous localization and mapping (SLAM) system used in accordance with the present technology.

FIG. 1C illustrates the SLAM system of FIG. 1B mounted on a UAV.

FIG. 2 is a flowchart of a method for point cloud reprojection.

FIG. 3A shows LiDAR data points classified by type.

FIG. 3B shows a false color rendering (in grayscale) of LiDAR data points with buildings highlighted.

FIG. 3C shows a topographic map having contour lines illustrating lines of constant elevation.

FIG. 3D illustrates topographic map after being updated based on the breaklines for each building and the routed contour lines around each building.

FIG. 3E illustrates a process of determining LiDAR points associated with the ground.

FIGS. 4A and 4B illustrate a method for automatically updating a topographic map in accordance with the present technology.

FIG. 5 shows a LiDAR dataset acquired by flying a drone-mounted LiDAR system in a raster pattern over a house, field, and trees.

FIGS. 6A and 6B illustrate a process for alignment and/or localization of differently acquired LiDAR datasets.

FIG. 7 illustrates a method for point cloud alignment.

### DETAILED DESCRIPTION

Acquiring survey data with a drone-mounted LiDAR sensor may be faster and safer than acquiring ground survey data using conventional survey techniques. The LiDAR dataset can be registered to one or more ground control points (GCPs) marked with handheld or vehicle-mounted GPS receivers. The surveyor can process the raw LiDAR dataset, also called a raw point cloud, using software running on a local processor or a cloud-based processor to get a processed LiDAR dataset that has contour lines and can be coded or marked (e.g., color-coded) to indicate different layers, including the ground, roads, vegetation, and buildings. The surveyor can use the processor and the processed LiDAR dataset to create design-level topographic surfaces in three-dimensional (3D) computer-aided design (CAD) software. These design-level topographic surfaces integrate the LiDAR dataset with maps of existing infrastructure, including sidewalks, roads, railroads, sewers, power lines, and other utilities.

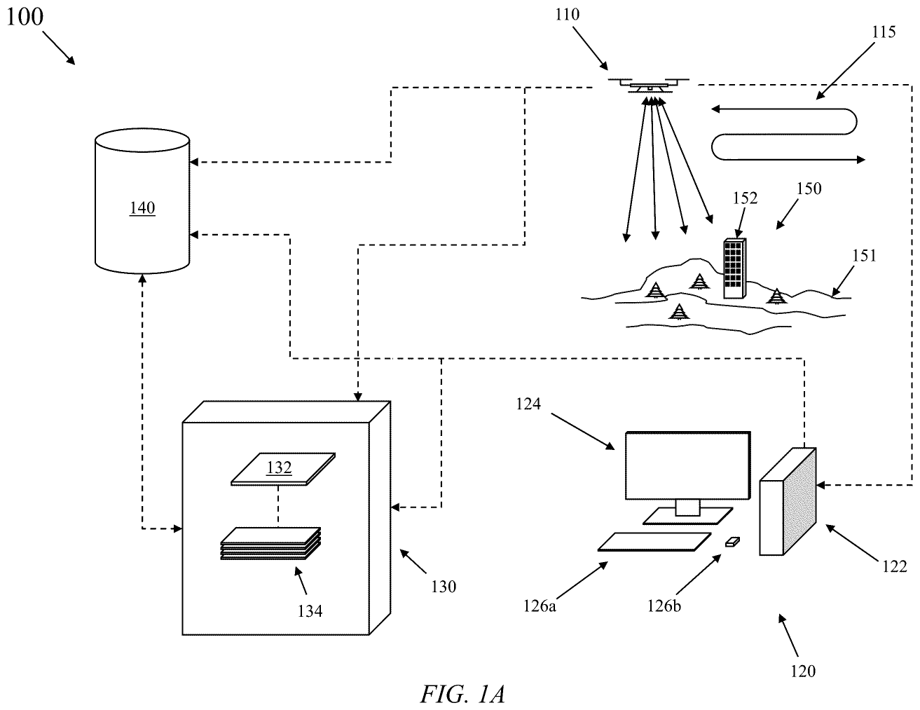

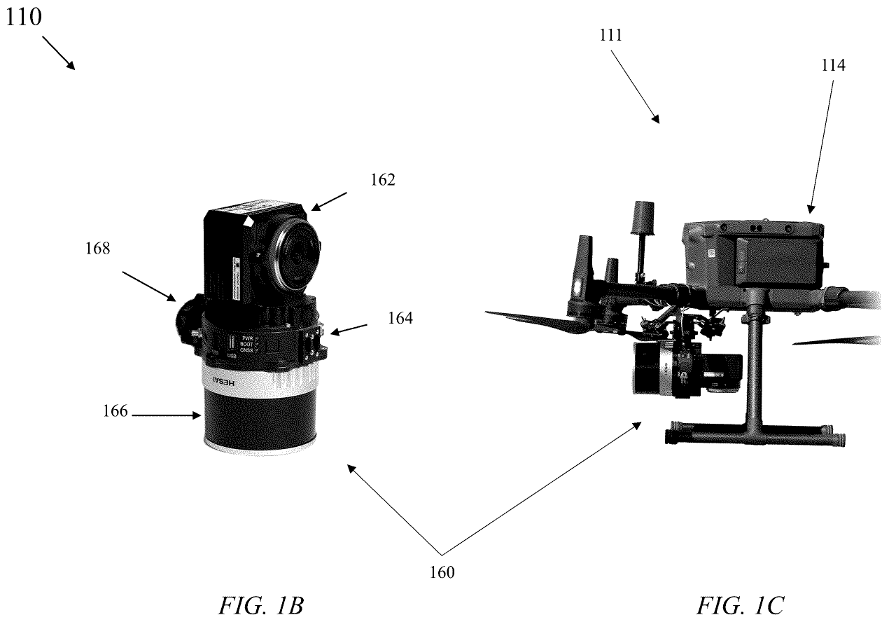

FIG. 1A illustrates a system 100 for collecting and processing LiDAR data of an environment 150 in accordance with the present technology. One or more components of system 100 may be used to perform any, some, or all steps of any methods disclosed herein. System 100 may include a measurement system 110 (e.g., one or more LiDAR sensors mounted on one or more unmanned aerial vehicles (UAVs), a ground-based LiDAR sensor, an unmanned ground vehicle (UGV) including one or more measurement sensors, etc.) configured to perform a ground survey or other profile of a landscape. Measurement system 110 may include one or more sensors including LiDAR sensors, radar sensors, inertial measurement units (IMUs), geolocation sensors (e.g., global positioning system (GPS), global navigation satellite system (GNSS), Globalnaya Navigatsionnaya Sputnikovaya Sistema (GLONASS), or similar sensors), time-of-flight (ToF) sensors, gyroscopic sensors, barometers, altimeters, hygrometers, or any suitable sensors.

Measurement system 110 may follow flight path 115 as measurements are being performed. Flight path 115 may be digitally represented by one or more parameters including altitude, speed, direction of travel, geolocation point, power level, voltage level, current level, battery state of charge, flight time, distance, measurement of signal strength, threshold of any of the foregoing parameters, IMU parameters, suitable fight parameters related to operation of UAV 111, or a combination of any of the foregoing parameters.

Flight path 115 and associated digital representation may further depend on and/or include parameters of measurement system 110 including LiDAR measurement distance, scan angle, intensity of a reflected measurement signal or threshold intensity, an RGB value or values of a reflected measurement signal or similar color information, laser time range or threshold laser time range, laser scan angle or threshold laser scan angle, or any suitable information related to UAV flight. For example, processor 132 may determine that LiDAR data representing environment 150 (including ground 151 and building 152) is incomplete because only a portion of building 152 was captured by measurement system 110 during a first scanning flight. Processor 132 may create a digital representation of flight path 115 using the above parameters of measurement system 110 based on requirements for additional LiDAR data as well as distances from building 152, height of building 152, dimensions of building 152, material of building 152, etc., that will be captured by measurement system 110 during a second scanning flight with updated flight path 115.

Flight path 115 may be determined, updated, modified, executed, altered, removed, or added to by controller 114, processor 132, or any suitable processor.

A UAV may be operated to follow a flight path based on an object such as a building. For example, a processor (e.g., controller 114, processor 132, or any suitable processor) may determine that more information is needed about an object and operate the UAV to follow a flight path around the object to collect additional measurement information about the object. The processor may determine a flight path based on existing measurement data for an object, such as LiDAR data points associated with the object. The processor may determine that an object such as a building was scanned by a LiDAR sensor only from one side, or at least one side of the object has not been scanned and therefore the LiDAR point cloud for the object is incomplete. The processor may then determine a flight path allowing additional measurement data to be collected to fill in the missing data. A flight path may be determined based on any of the above parameters including measurement system 110 parameters.

System 100 may include a user interface 120 configured to allow a user to view, manipulate, interact with, modify, update, delete, or add data such as survey data captured by measurement system 110. User interface 120 may include a computing device 122 (e.g., a computer, a tablet, a smartphone, a laptop, a desktop computer, or similar computing device), a display 124 (e.g., a monitor, a touchscreen, a smartphone screen, a wearable display, a TV, a projector, or any suitable display), and one or more user inputs 126a and 126b. User interface 120 may itself be a tablet, a smartphone, a web browser, a terminal, a kiosk, a heads up display (HUD), a touchscreen, or similar device. User interface 120 may include one or more of user inputs 126a and 126b, which may be a keyboard, a mouse, a touchpad, a trackpad, a stylus, a touchscreen, a joystick, a video game controller, an artificial reality (AR) or virtual reality (VR) input such as a wearable glove, visor, IMU, motion sensor, acceleration sensor, computer vision system (e.g., a system for recognizing human gestures, gaze detection, body motion, or the like), or any suitable input.

System 100 may include server 130 configured to perform one or more calculations on data received from measurement system 110. Server 130 may additionally store, modify, update, remove, add, alter, delete, or otherwise interact with data generated by measurement system 110 or similar measurement system. Server 130 may include one or more processors 132 such as one or more central processing units (CPUs), graphics processing units (GPUs), FPGAS, ASICs, or any suitable processor. Server 130 may include one or more memory modules 134 such as random access memory (RAM), dynamic random access memory (DRAM), static random access memory (SRAM), flash memory, solid-state drives, or similar data storage media. One or more memory modules 134 may store data for operating server 130, survey data, LiDAR point cloud data, data related to measurement system 110 including IMU data, geolocation data, operational data, sensor data, flight data, sensor data (e.g., camera data, LiDAR data, time-of-flight (ToF) data, gyroscopic data, barometric data, altimetric data, hygrometric data, or any data generated by or associated with measurement system 110), or other data. Server 130 may include a cloud server, a distributed computing system, a remote computing system, a datacenter, a desktop computer, or any suitable server configuration.

System 100 may include storage 140. Storage 140 may include non-volatile memory configured to store data related to measurement system 110 including LiDAR point cloud data, camera data, survey data, coordinate reference system (CRS) data, projected coordinate system data, flight path data, IMU data, time-of-flight (ToF) data, gyroscopic data, barometric data, altimetric data, hygrometric data, or any data generated by or associated with measurement system 110. Storage 140 may be communicatively coupled to any of measurement system 110, user interface 120, and/or server 130. Each of measurement system 110, user interface 120, server 130, and/or storage 140 may be configured to transmit data to and from each other component in system 100.

FIGS. 1B and 1C illustrate the measurement system 110 in greater detail. Measurement system 110 may include a UAV 111 with a simultaneous localization and mapping (SLAM) system 160. FIG. 1B illustrates SLAM system 160. SLAM system 160 may include any of camera 162, IMU 164, LiDAR sensor 166, and GPS receiver 168.

FIG. 1C illustrates UAV 111, which may include controller 114 configured to operate UAV 111. For example, controller 114 may control the UAV 111 in flight, respond to commands from a remote user through a remote controller, operate SLAM system 160 and components including camera 162, IMU 164, LiDAR sensor 166, and/or GPS receiver 168, and may store or transmit data including surveying data, flight data, command data, environmental data, or any suitable data. Controller 114 may include one or more processors such as central processing units (CPUs), field-programmable gate arrays (FPGAs), application-specific integrated circuits (ASICs), or the like. Controller 114 may include one or more memory modules such as random access memory (RAM), dynamic random access memory (DRAM), static random access memory (SRAM), flash memory, solid-state drives, or similar data storage media.

When mounted on an aerial drone, SLAM system 160 can be used to obtain full-coverage, 360° LiDAR data, for example, at rates of about 1,280,000 points per second and within about 0.5 cm range accuracy. The LiDAR system can also acquire images with the camera and take GPS measurements with the GPS receiver while acquiring the LiDAR data with the LiDAR sensor.

LiDAR sensor 166 acquires data by transmitting short pulses of light, which reflect or scatter off the ground, buildings, vegetation, and other surfaces in the LiDAR system's environment, and detecting the reflected or scattered light. LiDAR sensor 166 also measures the time elapsed between transmitting a given pulse and detecting the corresponding returns (the scattered or reflected portions of this pulse). This time corresponds to the round-trip travel time, at the speed of light, from the lidar sensor to the surface that generated the return. The raw LiDAR dataset is often represented as a raw point cloud, where each point in the raw point cloud corresponds to a different return. Each point has properties called components, which may vary with the format of the raw point cloud but generally include the x, y, and z coordinates of the corresponding surface, the intensity of the return, the pointing angle of the lidar sensor, and the GPS time and coordinates of the LiDAR sensor when it detected the return, among others.

### 1. Reprojecting Datasets

The spatial coordinates in a raw point cloud or other raw LiDAR dataset are typically given in a type of CRS called a projected coordinate system. In a projected coordinate system, locations are represented using Cartesian coordinates on or above a planar surface created by a map projection, such as a Mercator projection. There are hundreds of different projected coordinate systems, some of which are for specific regions or purposes. LiDAR sensors often provide raw point clouds and other LiDAR datasets in one of the sixty Universal Transverse Mercator (UTM) projected coordinate system zones.

In many cases, it is useful or desirable to reproject LiDAR datasets, that is, to transform them from one coordinate reference system to another coordinate reference system. When preparing a survey of land in California from LiDAR data in UTM World Geodetic System (WGS) 84 Zone 26N, for example, it may be helpful to project the LiDAR data into the appropriate zone of the California State Plane Coordinate System. The selected projected coordinate system may depend on the intended use for the processed LiDAR data.

Unfortunately, reprojecting LiDAR datasets can be time consuming, resource intensive, and error prone. To alleviate these problems, the inventors have developed a process of converting raw LiDAR datasets into a format that allows faster parallel processing and easier projecting/reprojecting workflows. To start, a user acquires a raw LiDAR dataset (e.g., in the form of a raw point cloud) using a LiDAR system like the one shown in FIGS. 1A-1C and provides it to a processor such as processor 132. If the processor is a cloud-based processor (e.g., a server), then the user can upload the raw LiDAR dataset to the cloud-based processor via suitable network connection.

A raw LiDAR dataset may include nodes representing individual measurement points. Each measurement point may include three-dimensional coordinates relative to an origin. The origin of the coordinate system for the raw LiDAR dataset may be defined based on a geolocation system, a first coordinate system such as UTM or WGS84, fiducial marker, or other suitable origin. Each measurement point may further include values describing an intensity of a reflected measurement signal, an RGB value or values of a reflected measurement signal or similar color information, laser time range, laser scan angle, inertial navigation system information, geolocation position, and the like.

The processor converts the raw LiDAR dataset into a Cloud Optimized Point Cloud (COPC) file. A COPC file is a LAZ 1.4 file that stores point data organized in a clustered octree. (The LAZ 1.4 file format is a compressed LiDAR data format suitable for transferring large amounts of LiDAR data and is a losslessly compressed version of the LASer 1.4 (LAS 1.4) file format.) The COPC file contains a variable length record (VLR) that describes an octree organization of data that are stored in LAZ 1.4 chunks. An octree is a tree data structure in which each internal node has exactly eight children. A COPC file clusters the storage of the octree as variably chunked LAZ data in a single file. This allows the data to be consumed sequentially by any reader that can handle variably chunked LAZ 1.4 data files (LASzip, for example), or as a spatial subset for readers that interpret the COPC hierarchy. The COPC file serves as the canonical dataset for visualizing and processing the LiDAR data.

The processor also creates a parallel copy of the LiDAR data file that contains only the original x, y, and z components for each point in the original (uploaded) point cloud. Like the COPC file, the parallel file stores the data in an octree data structure. The processor uses the parallel copy of the LiDAR data file to reproject the dataset instead of the COPC file or the raw LiDAR dataset. During the reprojection process, the x, y, and z components from the parallel file are used as the data to be reprojected.

To reproject the data, the processor loads each node of the octree from the canonical COPC file and the parallel file (one node at a time from each file). For each node, the processor takes the x, y, and z coordinates from the parallel file, reprojects them into the desired coordinate reference system, and puts the resulting values in the canonical COPC file. In other words, the processor determines reprojected Cartesian coordinates from the parallel file, then merges the reprojected Cartesian coordinates into the canonical dataset. Formatting the canonical and parallel files in an octree format and processing each node of the octree separately is substantially faster (e.g., 32-64 times faster) than traditional reprojection methods, which require loading an entire LAS or similar file (which can be tens or hundreds of gigabytes in size) into volatile memory and processing the file serially.

Traditional processing of LiDAR files may further require large amounts of processing power. The present technology has the benefit of parallelizing the storage and processing of LiDAR data. In particular, loading the files in smaller octree-based chunks means that memory storage requirements may be decreased from tens or hundreds of gigabytes to tens of megabytes (enough for each chunk rather than enough for the entire file). Further, processing data using an octree format eliminates the need to re-index the data during a reprojection process and allows the data to be processed in parallel using parallel processor cores. LiDAR data stored in traditional formats that do not use octree structures may require serial processing of data because altering a data entry may change the size of that data and require re-indexing the rest of the data after the altered data is reinserted into the file. Thus, attempting to process multiple data portions of a traditionally formatted LiDAR data file would likely corrupt the file when a processor attempted to write each of the data portions back to the file.

With the present technology, each node has a defined size within the COPC file, and making changes to the data within a node does not change the overall length of the file. Accordingly, data within multiple nodes (e.g., x-y-z coordinate data) may be reprojected and rewritten to the COPC file simultaneously without re-indexing each of the nodes. This eliminates the requirement to process the COPC file serially; instead, parallel processing may be used. This may enable the 32-64-fold speed improvements highlighted above.

The parallel file can be stored for projecting the data into other coordinate reference systems. To reproject the reprojected data, the processor repeats the reprojection process: it opens both the canonical dataset (the canonical COPC file in the reprojected coordinates) and the parallel file (in the original coordinates), reprojects the original coordinates into the new coordinate reference system and writes the new coordinates into the canonical dataset.

The use of a parallel file and a canonical COPC file has the further benefit of eliminating error compounding from multiple reprojections. Any reprojection process from a first coordinate system to a second coordinate system will introduce some error due to rounding, data storage precision, and desired coordinate system precision. If LiDAR data is reprojected from coordinate system A into coordinate system B, and then from coordinate system B into coordinate system C, the reprojection error at each step will compound. This also occurs even when reprojecting LiDAR data from coordinate system A into coordinate system B, from coordinate system B back into coordinate system A, and then from coordinate system A into coordinate system C (and may in some cases be worse than projecting from A to B to C). However, utilizing a parallel file ensures that each reprojection includes only a single instance of reprojection error. For example, if LiDAR data is reprojected from coordinate system A into coordinate system B, but then it is realized that the data should be reprojected into coordinate system C, the present technology allows for a reprojection from A to B and, separately, from A to C, eliminating the error compounding that would occur during the reprojection from B to C.

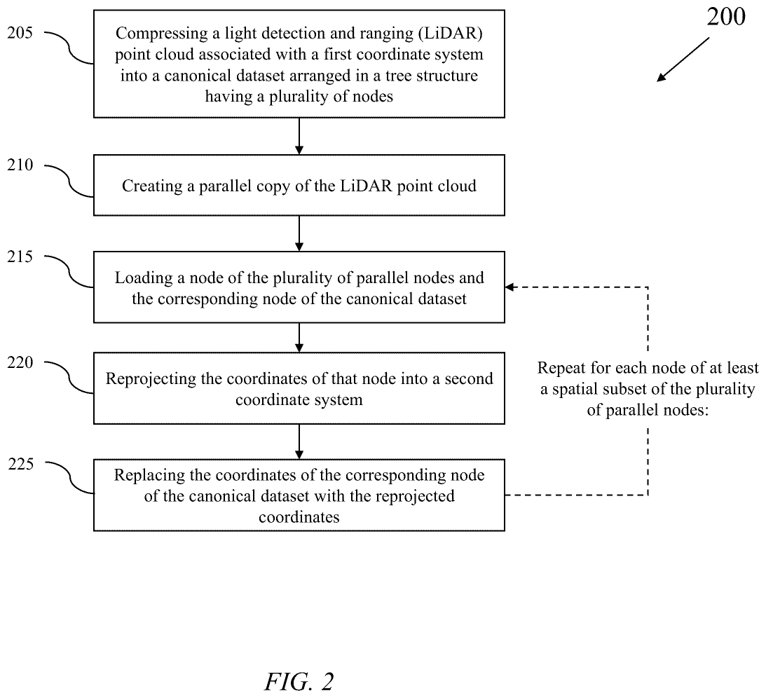

FIG. 2 is a flowchart of a method 200 for point cloud reprojection. Method 200 includes blocks 205-225. Any, some, or all blocks of method 200 may be performed by one or more components of system 100 including measurement system 110, SLAM system 160, user interface 120, server 130 (including processor 132 and one or more memory modules 134), and/or storage 140.

At block 205, a processor compresses a LiDAR point cloud associated with a first coordinate system into a canonical dataset arranged in a tree structure having a plurality of nodes. Each node comprises coordinates. For example, the coordinate of a node may describe the location of a node in three-dimensional space. The coordinates may belong to a three-dimensional coordinate system such as a Cartesian coordinate system, a spherical coordinate system, a cylindrical coordinate system, a polar coordinate system, or any suitable three-dimensional coordinate system. Each node (equivalently, parent node) is associated with one or more children or child nodes. Each node may have the same number of children, for example, eight children. Two separate nodes may have differing numbers of children.

The tree structure may be an octree structure. An octree structure is a series of nodes, each node having eight children or child nodes. Octree structures may be utilized to partition a three-dimensional space by recursively subdividing the space into octants. In an embodiment, each node may have a number of equally-spaced children. The children may each have the same number of equally-spaced children and so on until nodes cannot be subdivided further.

The canonical dataset may be segmented into a plurality of variable-length chunks. For example, each chunk may include a node and its immediate child nodes. At the end or edges of a LiDAR point cloud record, each node may have fewer than eight children.

The compression may be a lossless compression. For example, block 205 may include compressing a LAS 1.4 file into the losslessly compressed LAZ 1.4 format.

At block 210, the processor creates a parallel copy of the LiDAR point cloud. This parallel copy is arranged in the same tree structure and has parallel nodes corresponding to the nodes of the canonical dataset. The parallel copy of the LiDAR point cloud may include only the coordinates of the canonical dataset while omitting additional information such as intensity, laser scan angle, RGB values, etc.

At block 215, the processor loads a node of at least a spatial subset of the parallel nodes and the corresponding node of the canonical dataset. The spatial subset of parallel nodes may include all of the parallel nodes.

At block 220, the processor reprojects the coordinates of that node into a second coordinate system. Reprojecting the coordinates of that node comprises applying an affine matrix transformation to each of the coordinates in that node. For example, reprojecting the coordinates of a node may include applying an affine matrix transformation relative to an origin point or other reference point. The affine matrix transformation may include a translation, a rotation, a scaling, a reflection, or other suitable transformation.

At block 225, the processor replaces the coordinates of the corresponding node of the canonical dataset with the reprojected coordinates.

Blocks 215-225 may be repeated for each node of at least a spatial subset of the parallel nodes.

### 2. Automated Building Footprint Breaklines

LiDAR data can be used to generate topographic maps with contour lines that join points of equal elevation. One challenge with generating topographic maps from LiDAR data is placing the contour lines correctly near buildings and other structures. Surveyors and engineers often want contour lines to “break” at the footings or foundations of buildings. Traditionally, they do this by manually creating a “breakline” around the footings or foundation at the lowest elevation of the ground around the foundation. Manually creating breaklines is time consuming and costly.

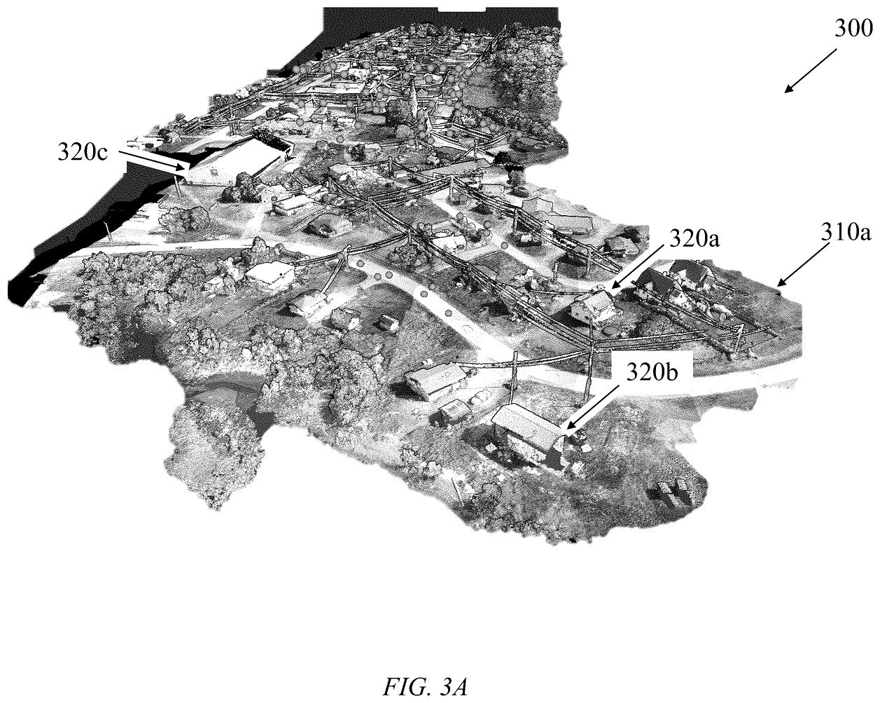

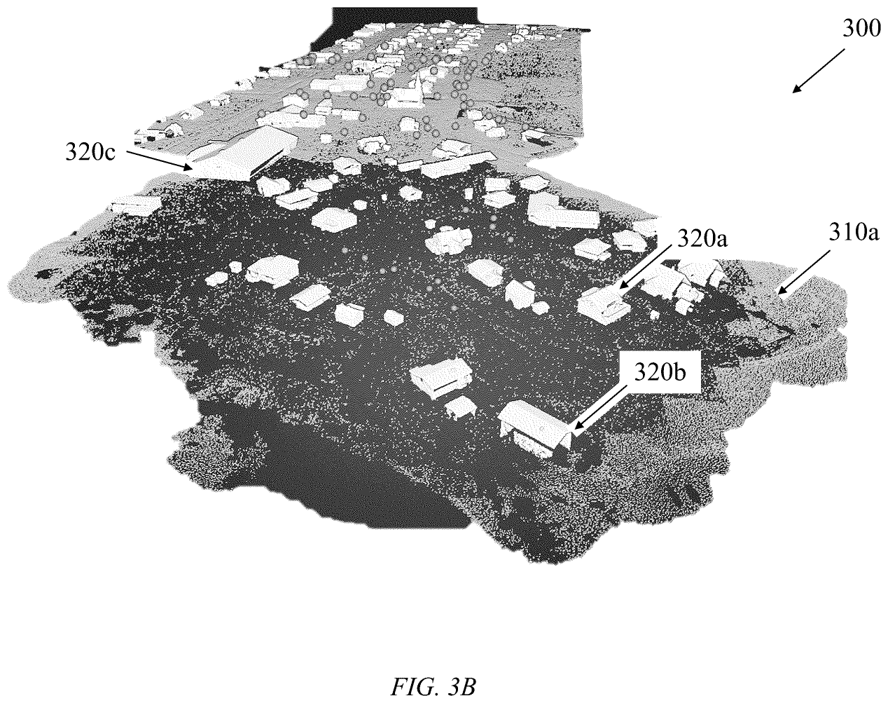

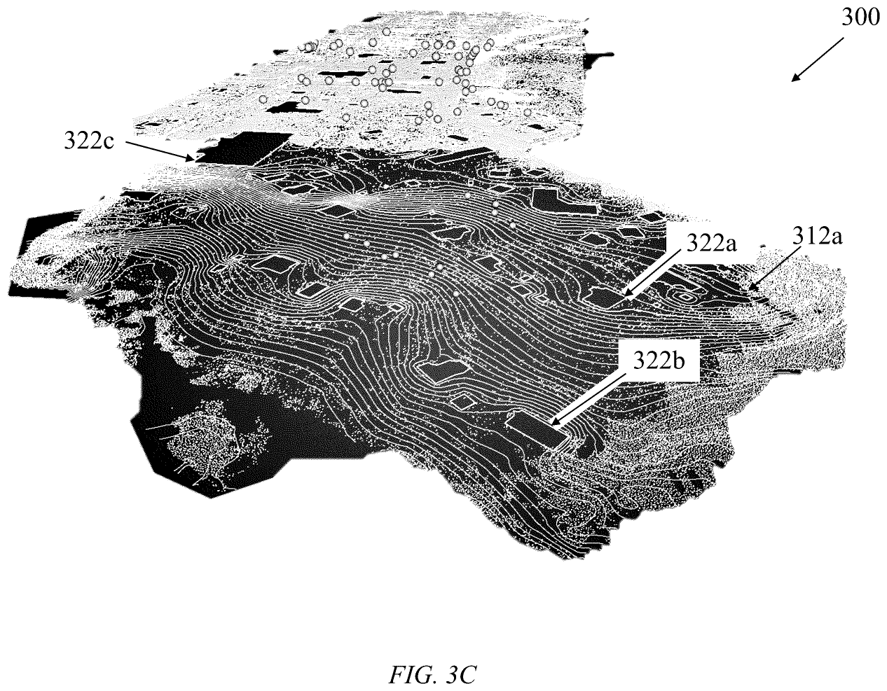

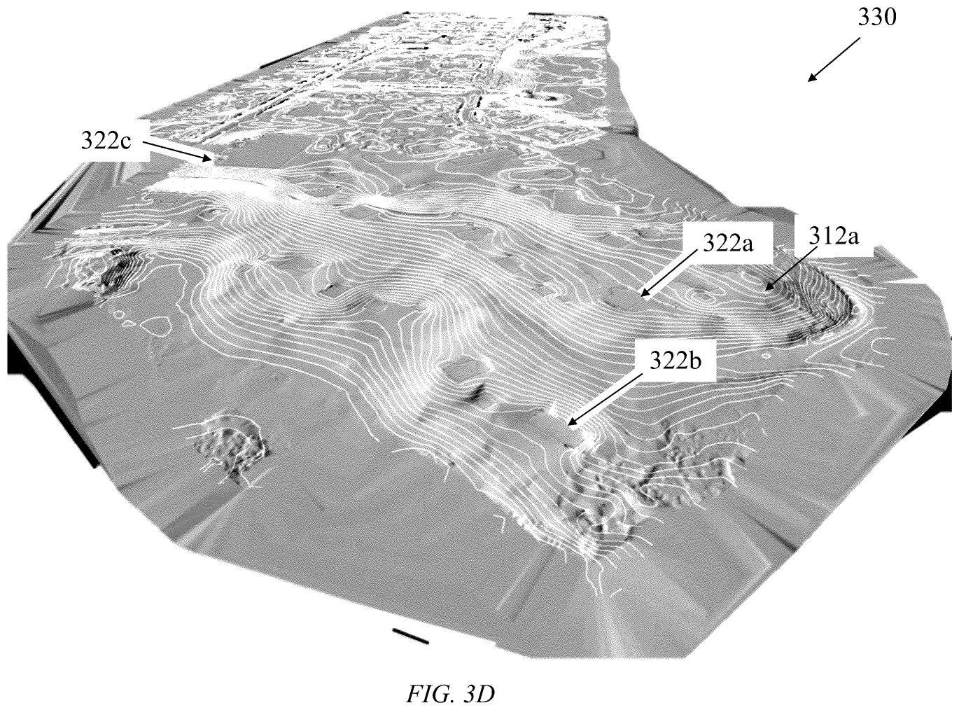

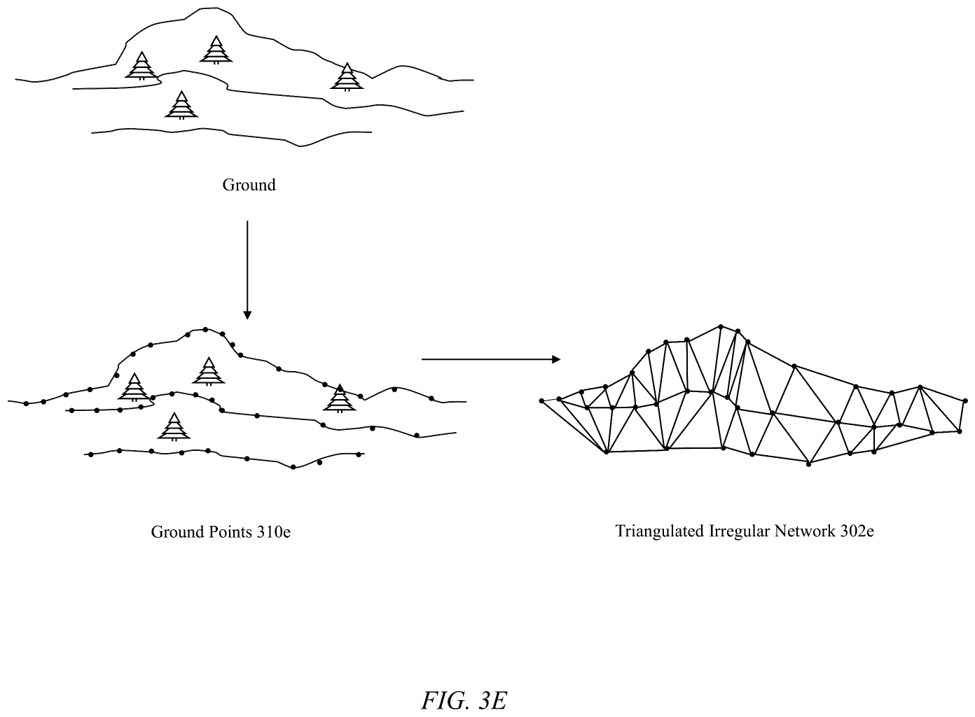

FIGS. 3A-3E illustrate stages of a process for automatically drawing breaklines from LiDAR data that is faster and less costly than manually drawing breaklines. To start, a processor such as processor 132 uses a machine learning or artificial intelligence process such as a machine vision algorithm, feature detection, edge detection, optical sorting, or any suitable process to classify the LiDAR data points 300 as being from the ground or objects such as buildings, vegetation, trees, roads, or other objects (which may be human-made or naturally occurring). FIG. 3A shows LiDAR data points 300 that have been classified as ground 310a, buildings 320a, 320b, 320c, etc. and rendered with shading and colors from color images that the LiDAR system acquired with the camera while gathering LiDAR data points 300.

FIG. 3B shows a false color rendering (in grayscale) of the scene from LiDAR data points 300 with buildings 320a-c highlighted (lighter shading). FIG. 3B further illustrates a number of other buildings identified by the processor as a result of the machine learning classification process. Processor 132 identifies the subset of LiDAR data points 300 associated with buildings 320a-c as well as the coordinates associated with the subset. Upon identifying buildings 320a-c, processor 132 may determine that buildings 320a-c have a substantially level base by comparing the elevations of the lowest LiDAR data points associated with buildings 320a-c (which are accordingly the surface elevation values for buildings 320a-c) or based on standard building practices.

Next, processor 132 generates a contiguous mesh such as a triangulated irregular network (TIN) surface from LiDAR data points 300 associated with ground 310a. An exemplary TIN 302e is illustrated in FIG. 3E. Processor 132 further generates contour lines 312a joining ground points having the same elevation value, illustrated in FIG. 3C. Processor 132 also generates a polygon 322a-c (e.g., a triangle, a rectangle, or otherwise suitable regular or irregular polygon) around a base of each group of points that is classified as a building such as buildings 320a-c as shown in FIG. 3B. Each polygon 322a-c includes at least three LiDAR data points representing the base of buildings 320a-c and the respective polygon is defined by the data points associated with each of 320a-c having the lowest elevation values.

Processor 132 overlays the polygons 322a-c onto the TIN surface to determine the lowest elevation along that polygon. Put differently, the processor finds the surface elevation (z coordinate) at the x, y coordinates of each vertex of the object such as buildings 320a-c, then sets the surface elevation of the entire building 320a-c to the surface elevation of the lowest vertex. Polygons 322a-c represent the lowest outermost perimeter points of buildings 320a-c and processor 132 defines these polygons 322a-c as the breakline for each building.

FIG. 3D illustrates topographic map 330 after updating based on the breaklines for each building 320a-c and the routed contour lines around each building. Each building (including buildings 320a-c) identified by processor 132 has been identified and collapsed into a breakline, which allows for contour lines 312a to be routed without interruption from objects including buildings 320a-c. This has a distinct advantage of providing a user of LiDAR data points 300 with a more accurate understanding of the landscape illustrated by LiDAR data points 300. This enables a user of LiDAR data points 300 and/or topographic map 330 to make better informed decisions regarding surveyed land.

FIG. 3E illustrates a process of determining LiDAR points associated with the ground. LiDAR ground points 310e are acquired by a suitable measurement system such as measurement system 110. Processor 132 then joins adjacent points to create a contiguous mesh from ground points 310e in the form of triangulated irregular network 302e.

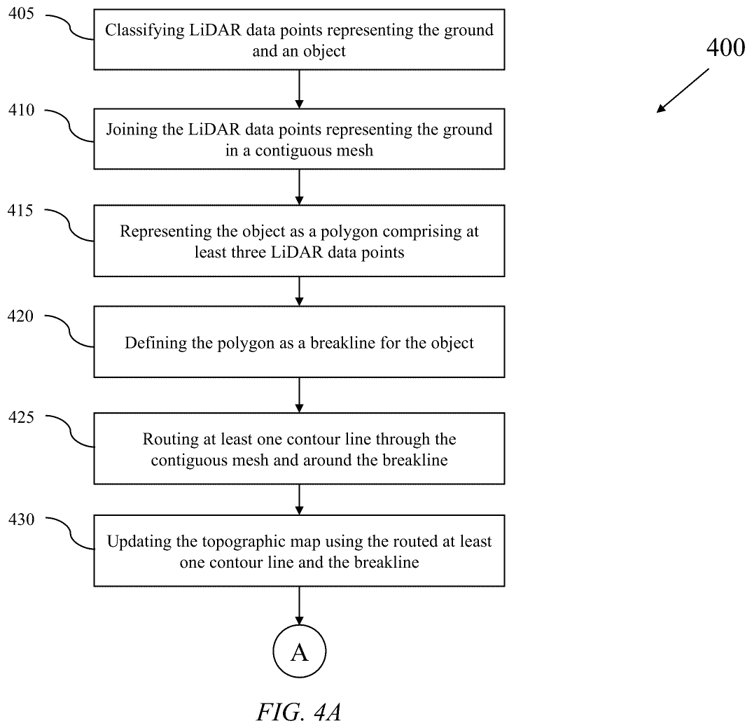

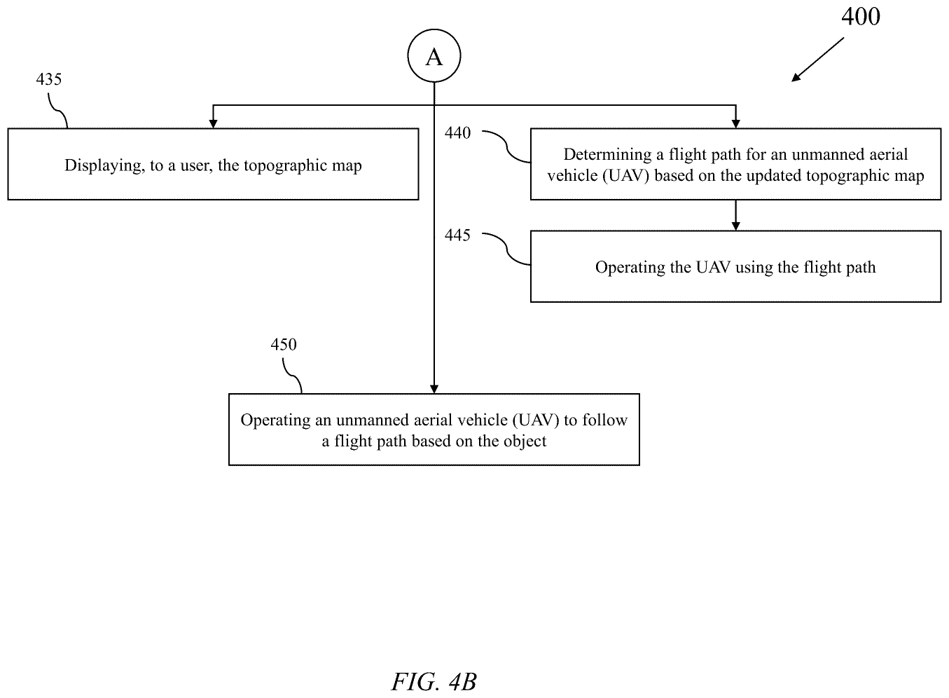

FIGS. 4A and 4B illustrate a method 400 in accordance with the present technology. Method 400 includes blocks 405-430 and may optionally include blocks 435-450. Any, some, or all blocks of method 400 may be performed by one or more components of system 100 including measurement system 110, SLAM system 160, user interface 120, server 130 (including processor 132 and one or more memory modules 134), and/or storage 140.

At block 405, the processor classifies data points representing the ground and an object. The object includes a substantially level base and may include a building, a road, or another human-made structure. Each of the LiDAR data points includes a surface elevation value.

At block 410, the processor joins the LiDAR data points representing the ground in a contiguous mesh. The contiguous mesh may include a triangulated irregular network, a quadrilateral structured grid, a hexahedral structured grid, or a hybrid grid including both structured polygonal mesh as well as unstructured or irregular polygonal mesh.

At block 415, the processor represents the object as a polygon comprising at least three LiDAR data points. The LiDAR data points have elevation values equal to the lowest elevation value of LiDAR data points associated with the object. The polygon may include a triangle, a quadrilateral, a regular polygon, or an irregular polygon.

At block 420, the processor defines the polygon as a breakline for the object.

At block 425, the processor routes at least one contour line through the contiguous mesh and around the breakline. To route the contour line through the contiguous mesh and around the breakline, the processor may determine a set of points within the contiguous mesh through which the contour line passes and connect the set of points using the contour line.

At block 430, the processor updates the topographic map using the routed contour line and the breakline. The processor may redraw the topographic map to show the routed contour line and the breakline or may replace a portion of the data of the topographic map corresponding to the routed contour line and the breakline.

Optionally, method 400 may include block 435. At block 435, the updated topographic map is displayed to a user. For example, computing device 122 and/or processor 132 may display the updated topographic map to a user by using display 124.

Optionally, method 400 may include blocks 440 and 445. At block 440, the processor may determine a flight path for a UAV based on the updated topographic map. The processor may determine that the data included in an existing topographic map is insufficient, and more LiDAR or other measurement data is needed for a complete survey of a mapped area. The processor may generate a flight path that would allow a LiDAR system to capture the necessary data.

At block 445, the UAV may be operated using the flight path. The UAV may be operated by any suitable processor or controller, including a ground-based controller, an on-board controller, a human-operated remote controller, or a combination thereof.

Optionally, method 400 may include block 450. At block 450, a UAV may be operated to follow a flight path based on the object. A processor may determine that more information is needed about an object and operate the UAV to follow a flight path around the object to collect additional measurement information about the object.

### 3. Determining the Setting of a Dataset and Setting of a Selected Area within a Dataset

A LiDAR system can acquire LiDAR data from a variety of settings, including urban, suburban, and rural areas. The characteristics of the LiDAR data vary from setting to setting—in rural settings, for example, there tend to be fewer buildings and more vegetation than in urban settings. Rural settings can also vary widely, from densely vegetated forest to sparse desert. The characteristics of each setting dictate the optimal data processing techniques to apply to the LiDAR data for that setting.

A processor can automatically determine the setting of a LiDAR dataset or a portion of a LiDAR dataset for choosing the optimal data processing technique to apply. The processor classifies the LiDAR data points in the LiDAR dataset or dataset portion as building, road, or other improved land using machine learning or artificial intelligence techniques for unstructured 3D data. The processor then assigns a binary value to each LiDAR data point indicating whether that LiDAR data point represents improved land (e.g., 1) or unimproved land (e.g., 0) and stores the resulting values in a GeoTIFF file, which embeds these binary values as geographic metadata. The GeoTIFF file matches geometrically the geography of the LiDAR data that it was created from. As a result, a bounding box drawn on the LiDAR data can quickly be overlaid on the GeoTIFF file to capture the data encoded in the GeoTIFF file for the bounding box.

The processor determines the setting of the LiDAR dataset by averaging the binary values across the portion of the GeoTIFF file corresponding to the bounding box and comparing the average to a threshold or set of thresholds. For instance, the processor can identify or classify the setting of LiDAR data within a bounding box selected by a user, then apply or recommend the optimal (e.g., fastest) technique for processing that LiDAR data based on the setting. The processor classifies the LiDAR data as rural if the GeoTIFF data within the bounding box has an average binary value of less than 0.33; semi-urban if the average binary value is from 0.33 to 0.66; and urban if the average binary value is 0.67 or more. The processor can select the appropriate processing technique or recommend the appropriate processing technique to a user based on the LiDAR data's setting (rural, semi-urban, or urban) or average binary value. Using the GeoTIFF file, the processor can estimate extremely quickly how rural, semi-urban, or urban the LiDAR data is within any arbitrary bounding box by calculating the average value of the average binary value within the bounding box.

### 4. Test LiDAR Datasets over Time to Determine if Calibration Is Warranted

The LiDAR point cloud accuracy depends on the LiDAR sensor's internal alignment and internal accuracy, the internal GPS receiver's accuracy, the IMU accuracy, and the relative alignment of the LiDAR sensor, GPS receiver, and IMU. The quality of LiDAR data acquired by the LiDAR system usually degrades over time, for example, as the LiDAR sensor ages or becomes uncalibrated. For instance, if the LiDAR system is jostled or dropped, then the components of the LiDAR sensor may become misaligned. The LiDAR sensor's lens may also become scratched or marred over time. And the photodetectors used to detect the LiDAR returns may become less sensitive over time and therefore less likely to detect weak returns. Unfortunately, LiDAR data acquired by a LiDAR sensor that is uncalibrated or not calibrated well enough generally cannot be used. Worse, measuring the calibration of a LiDAR sensor is difficult, time consuming, and involves expensive equipment.

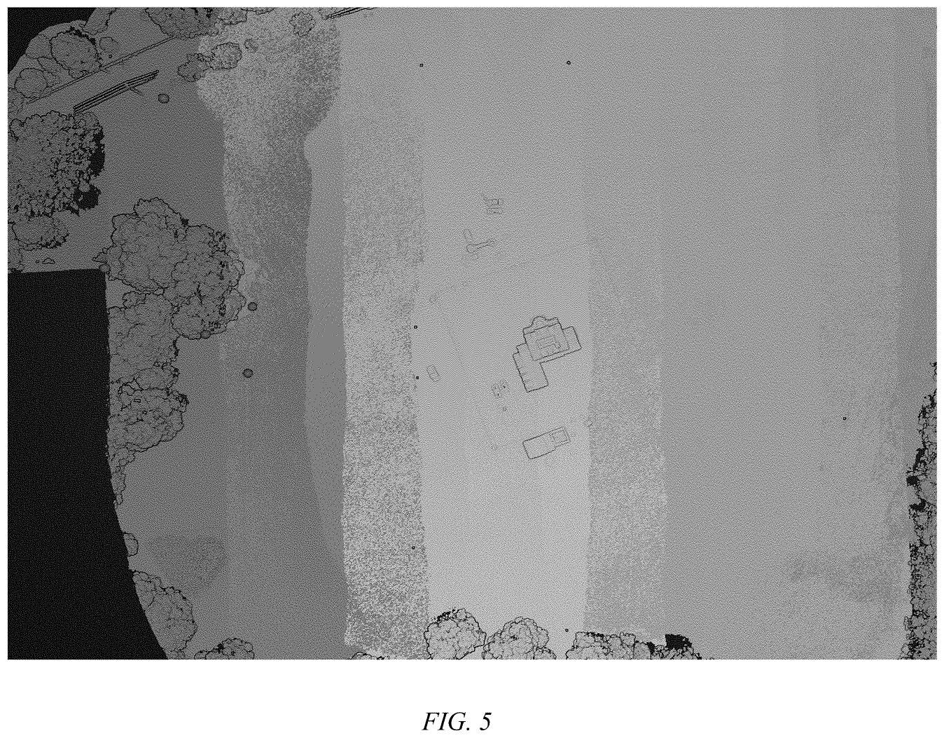

Fortunately, a processor can detect when a LiDAR sensor's performance has degraded beyond an acceptable point quickly and inexpensively by conducting statistical analyses of datasets acquired by the LiDAR sensor at different times. The datasets can be of the same scene/target or of different scenes/targets. The processor may conduct these statistical analyses on every dataset acquired by the LiDAR sensor or on only a subset of the datasets, for example, every tenth, twentieth, or hundredth dataset or on the first dataset acquired after a certain period, for example, a day, a week, or a month. For every statistical analysis, the processor identifies the well-defined (e.g., flat or smooth) area(s) in the dataset. For each well-defined area, the processor computes (1) an average thickness of a dataset for the distance between the LiDAR sensor and the ground (the height at which the drone flew the LiDAR sensor above the ground); (2) a standard deviation of the altitudes (z coordinates) among the data points representing the well-defined area; and, if the dataset includes multiple passes or flight lines of the same well-defined area as in FIG. 5, (3) an average deviation of the point cloud from those passes.

One or more of these measures (average thickness, standard deviation, and average deviation) tend to increase as the LiDAR sensor becomes less calibrated. Larger average thicknesses and standard deviations cause the flat areas to appear “fuzzy” instead of smooth, suggesting that the flat area is bumpier than it is in real life. And larger average deviations or peak-to-peak discrepancies between datasets acquired from multiple passes over the same flat area may cause the flat area to appear higher or lower than it is in real life. A large average deviation of the point cloud from multiple passes like those can also indicate strip alignment or boresighting issues for the LiDAR sensor.

FIG. 5 shows a LiDAR dataset acquired by flying a drone-mounted LiDAR system in a raster pattern over a house, field, and trees. The LiDAR system acquires a strip with every pass or scan in the raster pattern, with adjacent strips shaded differently and overlapping each other slightly in FIG. 5. In this case, the overlapping areas between several strips appear fuzzy or speckled, indicating that there was some drift in the drone's processed trajectory, the calibration of the LiDAR system is off, or both.

The processor stores these measures and compares them to the same measures for other datasets acquired by the LiDAR sensor. If the comparison shows that a particular measure has increased by more than an acceptable percentage or amount, the processor may indicate to a user that the LiDAR sensor is no longer properly calibrated or should be tested and inspected. Similarly, the processor may indicate to a user that the LiDAR sensor is no longer properly calibrated or should be tested and inspected if one or more measures are out of acceptable limits. The processor can analyze trends in LiDAR performance based on these historical measures and predict when the LiDAR sensor should be calibrated or tested (e.g., within a particular time period or after a certain number of measurements or certain amount of active measurement time).

### 5. Automated Noise Removal

The processor can also perform and use statistical analyses to remove noisy points from LiDAR point clouds. These noisy points often represent errant returns from above or below the surface(s) in the datasets. The errant returns can be caused by the sun, reflections, birds, insects, or particles in the air. Removing these errant returns from the dataset improves further processing of the dataset into usable deliverables. To identify the noisy data points caused by errant returns, the processor calculates the location of the mass of the data within a 3D space. If a point appears by itself, too far outside the statistical mass, then the processor marks the point as noise and can remove it. Put differently, the processor computes the z centroid of the point cloud and the standard deviation of the z coordinates of the points in the point cloud, then uses the z centroid as the center frequency and a multiple (e.g., 2, 3, 4, or 5) of the standard deviation as the bandwidth of a passband filter that it applies to the point cloud. The processor “passes” or keeps the points that lie within the passband (i.e., the points within a certain distance of the z centroid) and rejects or removes the points that lie outside the passband (i.e., the points that are farther than a certain distance from the z centroid).

### 6. SLAM/Terrestrial Point Cloud Alignment with Aerial Point Cloud

Localizing simultaneous localization and mapping (SLAM) data or terrestrial LiDAR data acquired with a ground-based LiDAR sensor to aerial LiDAR data acquired with a LiDAR on a drone or other aircraft typically requires a computer with lots of memory and processing power.

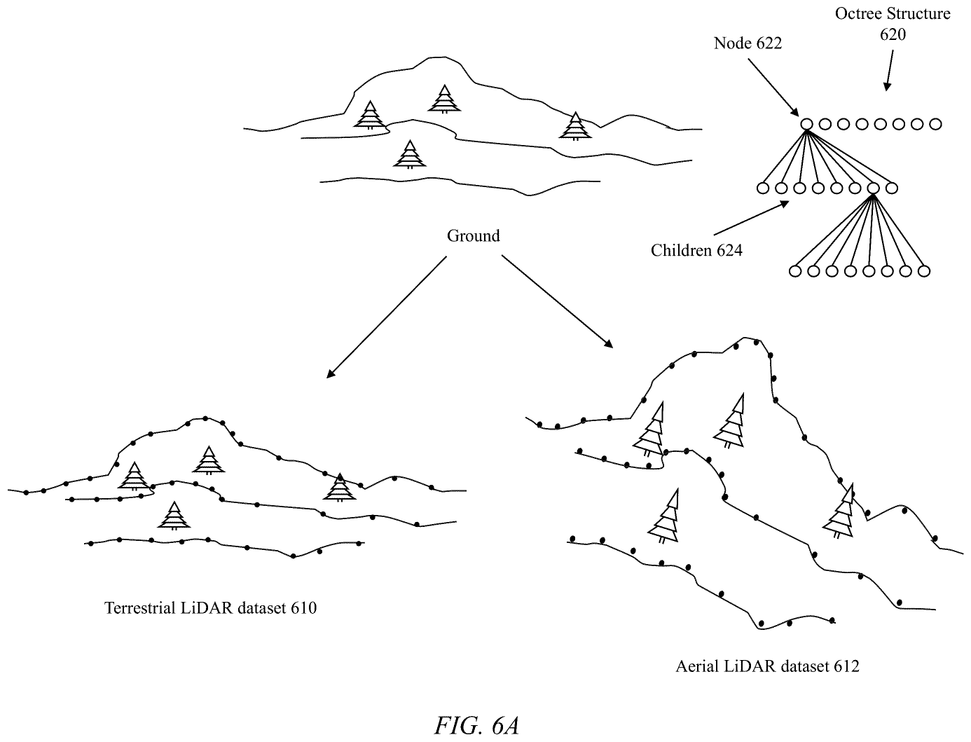

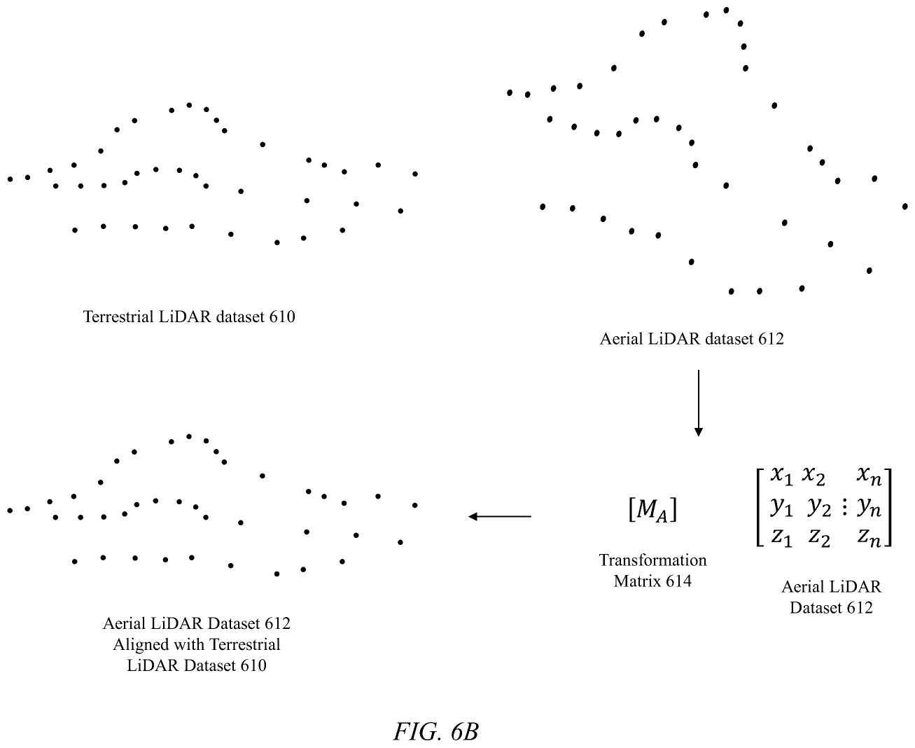

FIGS. 6A and 6B illustrate a process for alignment and/or localization of LiDAR datasets acquired in differing regimes (e.g., aerially acquired and terrestrially acquired). First, the processor such as processor 132 represents each point cloud for each LiDAR dataset as an octree structure such as octree structure 620 or other tree structure for each point cloud in each LiDAR dataset (e.g., SLAM/Terrestrial LiDAR dataset 610 and aerial LiDAR dataset 612). Octree structure 620 allows the processor to progressively load and unload points as the user navigates large point clouds, reducing both memory usage and processor load. Octree structure 620 includes one or more nodes 622 which are parent nodes to children 624 (equivalently, child nodes 624). In an octree structure such as octree 620, each parent node 622 will have eight child nodes 624.

Next, the processor selects or identifies corresponding points between the aerial LiDAR dataset 612 and the SLAM/terrestrial LiDAR dataset 610. The processor uses the corresponding data points to determine a transformational matrix 614 that encodes the relative translation and/or relative rotation between the frames of reference for the SLAM/terrestrial LiDAR dataset and the aerial LiDAR dataset. The corresponding points may be fiducial markers added in both datasets by a human or other actor to denote common features. In other words, the transformational matrix 614 translates and/or rotates data points in three dimensions but does not scale them. The processor applies the transformational matrix 614 to the aerial LiDAR dataset 612 to fit the aerial LiDAR dataset 612 to the SLAM/terrestrial LiDAR dataset 610 and allows the user to make fine adjustments to the fitted data. Alternatively, the processor can apply the transformation matrix to the ground control points (GCPs) for the SLAM/terrestrial LiDAR dataset 610 to transform terrestrial LiDAR dataset 610 into aerial LiDAR dataset 612.

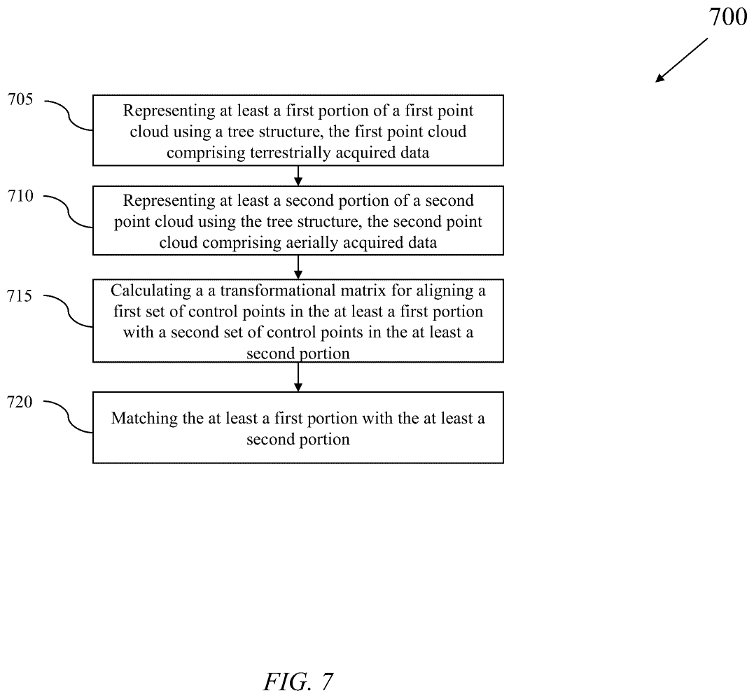

FIG. 7 illustrates a method 700 for point cloud alignment. Method 700 includes blocks 705-720. Any, some, or all blocks of method 700 may be performed by one or more components of system 100 including measurement system 110, SLAM system 160, user interface 120, server 130 (including processor 132 and one or more memory modules 134), and/or storage 140.

At block 705, a processor represents at least a first portion of a first point cloud using a tree structure. The first point cloud comprises terrestrially acquired data. The tree structure may be an octree structure.

At block 710, the processor represents at least a second portion of a second point cloud using the tree structure. The second point cloud comprises aerially acquired data.

At block 715, the processor calculates a transformational matrix for aligning a first set of control points in the first portion with a second set of control points in the second portion. The transformational matrix may be an affine transformation matrix, which may include one or more of a translation and/or a rotation.

At block 720, the processor matches the first portion with the second portion.

### 7. Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the components so conjoined, i.e., components that are conjunctively present in some cases and disjunctively present in other cases. Multiple components listed with “and/or” should be construed in the same fashion, i.e., “one or more” of the components so conjoined. Other components may optionally be present other than the components specifically identified by the “and/or” clause, whether related or unrelated to those components specifically identified. Thus, as a non-limiting example, a reference to “A and/or B”, when used in conjunction with open-ended language such as “comprising” can refer, in one embodiment, to A only (optionally including components other than B); in another embodiment, to B only (optionally including components other than A); in yet another embodiment, to both A and B (optionally including other components); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of components, and, optionally, additional unlisted items. Only terms clearly indicated to the contrary, such as “only one of” or “exactly one of,” or, when used in the claims, “consisting of,” will refer to the inclusion of exactly one component of a number or list of components. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more components, should be understood to mean at least one component selected from any one or more of the components in the list of components, but not necessarily including at least one of each and every component specifically listed within the list of components and not excluding any combinations of components in the list of components. This definition also allows that components may optionally be present other than the components specifically identified within the list of components to which the phrase “at least one” refers, whether related or unrelated to those components specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including components other than B); in another embodiment, to at least one, optionally including more than one, B, with no A present (and optionally including components other than A); in yet another embodiment, to at least one, optionally including more than one, A, and at least one, optionally including more than one, B (and optionally including other components); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for point cloud reprojection, the method comprising:
compressing, by a processor, a light detection and ranging (LiDAR) point cloud associated with a first coordinate system into a canonical dataset arranged in a tree structure having a plurality of nodes, each node comprising coordinates, and each node being associated with one or more children;
creating, by the processor, a parallel copy of the LiDAR point cloud, the parallel copy arranged in the tree structure and having a plurality of parallel nodes corresponding to the plurality of nodes of the canonical dataset;
for each node of at least a spatial subset of the plurality of parallel nodes,
loading, by the processor, that node and the corresponding node of the canonical dataset;
reprojecting, by the processor, the coordinates of that node into a second coordinate system; and
replacing, by the processor, the coordinates of the corresponding node of the canonical dataset with the reprojected coordinates.

2. The method of claim 1, wherein the tree structure is an octree structure.

3. The method of claim 1, wherein the canonical dataset is segmented into a plurality of variable-length chunks.

4. The method of claim 1, wherein the coordinates comprise Cartesian coordinates, polar coordinates, or spherical coordinates.

5. The method of claim 1, wherein reprojecting the coordinates of that node comprises applying an affine matrix transformation to each of the coordinates in that node.

6. The method of claim 1, wherein the compressing comprises a lossless compression.

7. The method of claim 1, wherein the at least a spatial subset of nodes of the plurality of parallel nodes comprises all of the nodes of the plurality of parallel nodes.

8. A method for automatically updating a topographic map, the method comprising:
classifying, by a processor, light detection and ranging (LiDAR) data points representing the ground and an object, the object having a substantially level base, and each of the LiDAR data points comprising a surface elevation value;
joining, by the processor, the LiDAR data points representing the ground in a contiguous mesh;
representing, by the processor, the object as a polygon comprising at least three LiDAR data points, the at least three LiDAR data points comprising elevation values equal to a lowest surface elevation value for the object;
defining, by the processor, the polygon as a breakline for the object;
routing, by the processor, at least one contour line through the contiguous mesh and around the breakline; and
updating, by the processor, the topographic map using the routed at least one contour line and the breakline.

9. The method of claim 8, wherein the contiguous mesh comprises a triangulated irregular network, a quadrilateral structured grid, a hexahedral structured grid, or a hybrid grid.

10. The method of claim 8, wherein the object comprises a building, a road, or another human-made structure.

11. The method of claim 8, wherein the polygon is a triangle, a quadrilateral, a regular polygon, or an irregular polygon.

12. The method of claim 8, further comprising displaying, to a user, the updated topographic map.

13. The method of claim 8, further comprising:
determining a flight path for an unmanned aerial vehicle (UAV) based on the updated topographic map; and
operating the UAV using the flight path.

14. The method of claim 8, further comprising operating an unmanned aerial vehicle (UAV) to follow a flight path based on the object.

15. A method for point cloud alignment, the method comprising:
representing, by at least one processor, at least a first portion of a first point cloud using a tree structure, the first point cloud comprising terrestrially acquired data;
representing, by the at least one processor, at least a second portion of a second point cloud using the tree structure, the second point cloud comprising aerially acquired data;
calculating, by the at least one processor, a transformational matrix for aligning a first set of control points in the at least a first portion with a second set of control points in the at least a second portion; and
matching, by the at least one processor, the at least a first portion with the at least a second portion.

16. The method of claim 15, wherein the matching comprises applying an affine transformation of the at least a first portion or the at least a second portion using the transformational matrix.

17. The method of claim 16, wherein the affine transformation comprises a rotation or a translation.

18. The method of claim 15, wherein the tree structure is an octree structure.
